(19) United States
(12) Patent Application Publication
(10) Pub. No.: US 2009/0078208 A1
(43) Pub. Date: Mar. 26, 2009

(54) Strip, dip and scrub

(76) Inventors: Dennis Lee Hakes, Burley, ID (US); Jean Ann Hakes, Burley, ID (US)

Correspondence Address: RICHARD L. MARSH, 4116 E. LATOKA, SPRINGFIELD, MO, 65809, US

(21) Appl. No.: 12/283,460

(22) Filed: Sep. 11, 2008

Related U.S. Application Data
(60) Provisional application No. 60/993,404, filed on Sep. 12, 2007.

(51) Int. Cl. A01J 7/04; A01J 5/00

(52) U.S. Cl. 119/14.18

(57) ABSTRACT

A mitt for scrubbing debris, applying germicidal dip and stripping milk from an animal's teat comprises an elongated bladder having an exfoliant material applied to one surface thereof, a liquid and air inlet port, a thumb strap, a hand strap and a pinch valve.

### RELATED APPLICATION DATA

This is a non-provisional application of Applicants' provisional application Ser. No. 60/993,404 filed 12 Sep. 2007.

### BACKGROUND OF THE INVENTION

1. Field of the Invention

This device is for scrubbing debris, applying germicidal dip, and stripping the milk from the animal's teats.

2. Prior Art Statement

The problem with current devices that apply the germicidal is that they are very wasteful and do not allow you to combine the three steps of strip, dip and sanitize in the same motion. In these devices currently used for applying germicidal, the teat is dipped into a reservoir of germicidal and removed quickly. The residue of this highly corrosive germicide (approximately 75%) does not adhere to the teat. It drips off the teat onto the floor and is washed into ponds and manure pits. These germicides are a hazard to clean water and crops. The debris is then removed in a second step of using a towel to wipe the teat. This not only takes time but creates loads of laundry using hundreds of gallons of water each day. If the teat needs to be stripped, it is yet a third step.

### SUMMARY OF THE INVENTION

This new device has been designed to apply germicide, scrub the teat, and strip the milk all in one step. The dip coverage on the skin of the teat is excellent and dip usage is greatly reduced because of less waste. The three procedures are done at one time.

### BRIEF DESCRIPTION OF THE DRAWINGS

FIG. 1 is a top plan view of the pump, valving and piping of the device of this invention for cleaning, scrubbing and applying germicidal.

FIG. 2 is a front view of the mitt of the device of this invention for cleaning, scrubbing and applying germicidal.

FIG. 3 is a rear view of the mitt of the device of this invention for cleaning, scrubbing and applying germicidal.

### DESCRIPTION OF THE PREFERRED EMBODIMENTS

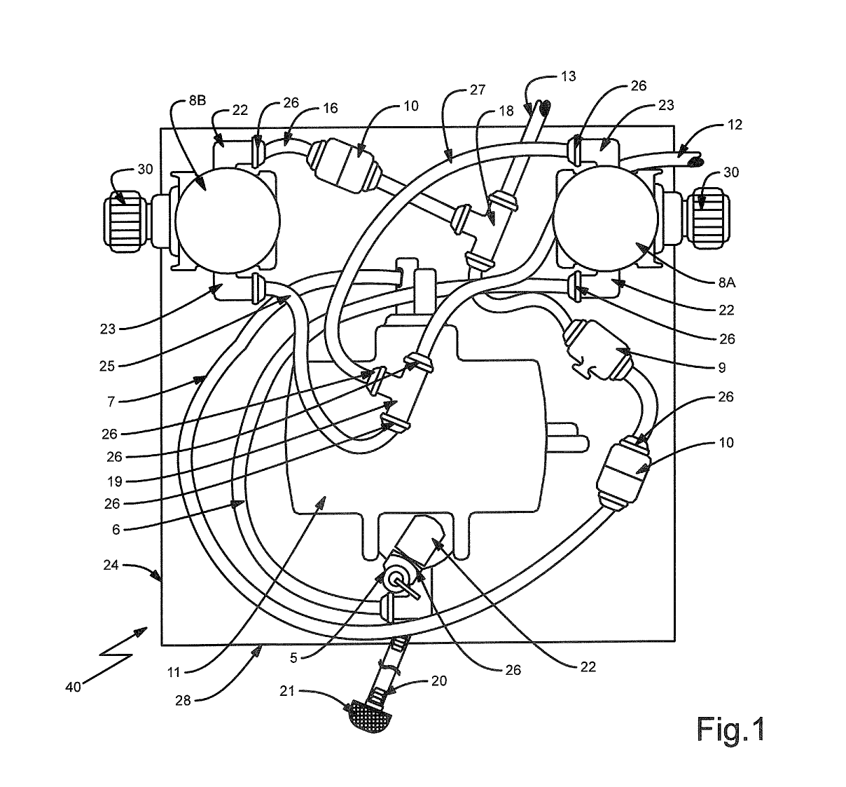

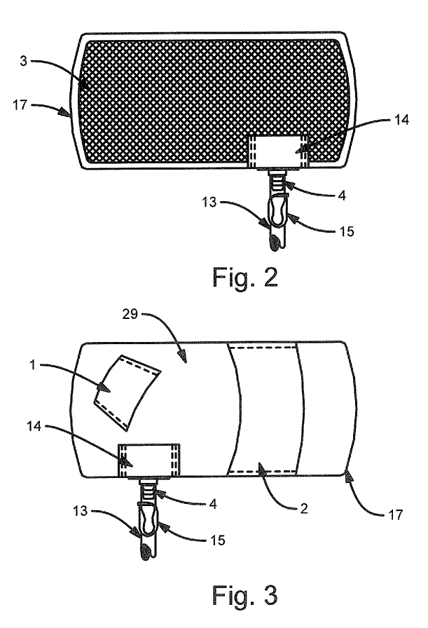

Referring now to FIG. 1, a teat strip, dip and scrub system 50 comprises a mitt 17 shown best in FIGS. 2 and 3 and a control unit 40 best shown in FIG. 1. Control unit 40 comprises a pump 11, air supply line 12, two pressure regulators 8A and 8B, air pump inlet hose 6, two one way check valves 10, liquid discharge line 7, liquid line orifice 9, air line Tee 19, mixture line Tee 18, liquid and air discharge line 13, regulated air discharge line 16, regulated air inlet hose 25, regulated air outlet hose 16, push to connect elbows 22, 23 and part of liquid supply line 5 all contained within a 12 inch cube PVC enclosure 24. A portion of liquid supply line 5 extends through one wall 28 of container 24 and is connected to a suction strainer 21 by a barbed hose connector 20. Though control unit 24 is preferably provided in cubic enclosure 24 and thus is a self standing unit, it is entirely possible within the scope of this invention to manufacture enclosure 24 as a circular enclosure wherein wall 28 fits upon a rim of a bucket such that liquid suction line 5 with suction strainer 21 thereupon may easily be inserted into the germicidal bucket while installing control unit 24 upon the bucket.

Beginning first with suction strainer 21, the function of all above named elements will be hereinafter fully described. Suction strainer 21 is a simple screen strainer to keep debris and coagulated or agglomerated germicide material from entering pump 11 to ensure proper operation of system 50, however, any strainer may be used for suction strainer 21 without departing from the scope of this invention. Suction strainer 21 is provided with barbed hose connector upon which liquid suction tube 5 is mounted by pushing an end of liquid suction tube 5 upon barbed connector 20 as is well known in the art of connecting flexible tubing. Liquid suction tube 5 is shown broken to indicate that liquid suction tube 5 is sufficiently long to extend from suction strainer 21 to pump 11 without straining liquid suction tube 5. Suction strainer 21 is placed into a container of germicide and retained therein by the weight of suction strainer 21. An end of liquid suction tube 5 opposite suction strainer 21 has a push-to-connect connector 26 affixed thereto, push-to-connect connector 26 connected to an elbow 22 installed in a suction side of pump 11. Though suction strainer 21 is generally intended to be slipped into a larger container of germicide, such as a bucket, use of smaller containers of germicide are fully within the scope of this invention as suction strainer 21 may be an in-line strainer wherein a container of germicide is connected to a hose also attached to suction strainer 21. Furthermore, suction strainer 21 may be sufficiently small in order to be inserted into a small container, such as a quart bottle, of germicide. Returning to the preferred embodiment, it will become readily apparent that push-to-connectors 26 are used throughout system 50 in order to quickly disassemble system 50 for cleaning between milking runs. In the preferred embodiment, liquid suction line 5 is a ⅜ inch diameter tube and has a ⅜ inch push-to-connect connector 26 installed at an end thereof to connect directly to a ⅜ inch push-to-connect elbow 22, though of course, any other suitable diameter of tubing or pipe may be used without departing from the scope of the claims.

Pump 11 is mounted within enclosure 24 and is connected to a source of air for driving pump 11. Though an air driven pump 11 is preferred, any other pump may be used to advantage. Since a source of air is generally available in a milking barn, air is supplied to control unit 40 through an air supply line 12 which is connected to both pressure regulators 8A and 8B through a push-to-connect Tee 19. In the preferred embodiment, push-to-connect Tee 19 is a ¼ inch Tee and push-to-connect connectors 26 on air inlet hose 12, regulated air inlet hose 25 and air inlet hose 27 are also ¼ inch connectors though, of course, any suitable size of tubing and connectors are within the scope of the appended claims. Following an air path to pump 11, air passes through one arm of Tee 19, through an inlet hose 27 to pressure regulator 8A. Inlet hose 27 is also provided with a push-to-connect connector 26 on both ends thereof and thus quickly connected to Tee 19 and to a ¼ push-to-connect elbow 23 on regulator 8A. From regulator 8A, air flows through regulated air inlet hose 6 which is likewise provided with push-to-connect connectors 26 on both ends thereof, to pump 11, regulated air inlet hose 26 connected to pump 11 through an elbow 22 mostly hidden underneath liquid suction line 5. Regulated air inlet hose 26 is preferably a ⅜ inch diameter flexible tube, however, any tube may be used to advantage. As is well known in the art, regulator 8A is used to control air pressure and volume to air pump 11 to control the rate of liquid pumping provided by air pump 11. From pump 11, liquid germicide is provided under pressure to mitt 17 through liquid discharge line 7, one-way check valve 10, orifice 9, mixing Tee 18 and ultimately through air and liquid discharge hose 13. Though not numbered in every location in FIG. 1, push-to-connect connectors 26 are provided on liquid discharge line 7, one-way check valve 10, orifice 9, elbows 22, 23 and mixing Tee 18 in a liquid path and on elbows 22, 23, regulated air discharge line 16 and one-way check valve 10 to mixing Tee 18 in an air path to mitt 17. Liquid discharge line 7 is preferably a ⅜ inch diameter flexible, clear polymeric tube, however, again it is within the scope of these claims to provide for any other tube or pipe.

In an air path, air flows from Tee 19 to regulator 8B, through air discharge line 16, one-way check valve 10 and into mixing Tee 18, air provided through regulator 8B designed to foam liquid germicide flowing through mixing Tee 18 thus providing a foamed germicide to mitt 17. As hereinbefore stated, regulator air inlet hose is ¼ inch diameter though regulated air outlet hose is ⅜ inch flexible, clear tubing and thus Tee 22 is a ⅜ inch Tee. Three eighths inch, one-way check valves 10 are provided in both liquid discharge line 7 and regulated air discharge line 16 to ensure that air is not blown backward through pump 11 into a germicide container and that liquid germicide is not forced into air line 12, and hence the milking air supply system that is supplying air to controller 40. Though it is preferred that push-to-connect connectors 26 be used throughout system 40, it is also within the scope of this invention to make fast all connections in the air path prior to one-way check valve 10 and to make fast air inlet connections through regulator 8A and to an inlet side of pump 11, it being fully understood that the primary objective of providing push-to-connect connectors 26 is for rapid disassembly, cleaning and re-assembly of control unit 40. Regulator 8B is used to control air pressure to mixing Tee 18 to ensure proper foaming of germicide and therefore, a proper cleansing of an animal's teat prior to milking. Regulators 8A and 8B are provided with control knobs 30 in order to regulate the air flowing therethrough.

Turning now to mitt 17 shown in FIGS. 2 and 3, mitt 17 is an elongate pad of exfoliate scrubbing material 3 affixed to a thin bladder 29, thin bladder 29 provided with a hand strap 2 and thumb strap 1 on one side thereof and an liquid inlet tube seal 14 on an edge thereof. Thin bladder 29 has a plurality of holes provided in one surface to which exfoliate scrubbing material 3 is affixed such that foamed germicidal material may easily flow from thin bladder 29 into exfoliate scrubbing pad material 3. Liquid inlet tube seal 14 has an barbed inlet connector 4 affixed thereto, barbed inlet connector 4 receiving an end of air and liquid discharge hose 13 from control unit 40. Air and liquid discharge hose 13 supplies a foamed germicidal material to mitt 17 therethrough, air and liquid discharge hose 13 provided with a pinch valve 15 to control flow of foamed germicide therethrough.

To operate this hand held device, simply slip your hand into the back of the scrubbing mitt 17 placing your thumb into 1 thumb strap and fingers into 2 the hand strap. Open with your thumb part 15, pinch valve, and allow the liquid and air to flow through 3 exfoliate scrubbing pad. With your hand bent in a half circle position, enclose the cow's teat with your hand and allow the liquid coming through 3 exfoliate material to come into contact with the skin of the cow's teat. As the liquid is applied to the cow's teat, work your hand in a scrubbing motion to remove any debris that is attached to the skin of the teat. After scrubbing debris from the skin of the teat, gently squeeze the teat starting at the base of the udder moving toward the end of the teat. Milk will flow through the orifice of the teat onto the floor which can be inspected for healthy conditions. Our device combines 3 milking procedures into one step. Step one is stripping the milk from the cow's teat to inspect for healthy conditions. Step two is applying the germicide to the skin of the teat to sanitize. Step three is scrubbing the skin of the cow's teat to make sanitary prior to harvesting milk from the cow.

This device operates because air inlet line 12 distributes air to both air controlling regulators. Regulator 8A controls the amount of air pressure that drives 11 liquid pump. The fluid is drawn up the suction tube 5 and pumped out the liquid pressure line 7 through a ⅜ one-way check valve 10 and the liquid is regulated by 9 the liquid pressure discharge orifice. The liquid discharge hose 13 is then connected by a ⅜ push-to-connect Tee 18 to the air regulated discharge line 16 coming from 8B. The air discharge line also has a ⅜ push-to-connect one-way check valve 10. The air and liquid discharge hose 13 then connects to 4, the inlet connector on the scrubbing mitt 17. Part 13, the air and liquid discharge hose, passes through 15, the thumb operated pinch valve, which either turns on or off the air and liquid. Since the flow of germicide is controlled by pinch valve 15 through to mitt 17 and the germicide is provide to mitt 17 as a foam, a great deal less germicide is used in the operation of preparing an animal's teat for milking and hence less caustic germicide is introduced into the environment as is prevalent with conventional methods of preparing an animal's teat for milking as has been set forth in the prior art statement.

While the present invention has been described with reference to the above described preferred embodiments and alternate embodiments, it should be noted that various other embodiments and modifications may be made without departing from the spirit of the invention. Therefore, the embodiments described herein and the drawings appended hereto are merely illustrative of the features of the invention and should not be construed to be the only variants thereof nor limited thereto.

We claim:

1. A mitt for scrubbing debris, applying germicidal dip and stripping milk from an animal's teat comprises an elongated bladder having an exfoliant material applied to one surface thereof, a liquid and air inlet port, a thumb strap, a hand strap and a pinch valve, said thumb strap affixed to one end of said elongated bladder on a surface opposite said exfoliant material, said hand strap spaced from said thumb strap and affixed to said surface opposite said exfoliant material and said liquid and air inlet port affixed to an edge of said elongated bladder between said thumb strap and said hand strap.

2. A mitt as in claim 1 wherein said bladder has at least one orifice in said one surface for admitting said air and liquid to said exfoliant material.

3. A device for scrubbing debris, applying germicidal dip and stripping milk from an animal's teat comprises a mitt, a pump unit and at least one connecting hose for connecting said mitt to said pump unit, said pump unit further comprising at least two air pressure regulators, a pump, connecting hoses, at least two one-way check valves and at least one Tee, said pump having a liquid inlet connected to a germicidal container and an air inlet connected to one said pressure regulator, said pump having an outlet connected by a connecting hose to one said one-way check valve, said one-way check valve connected by a connecting hose to one arm of an outlet Tee, another said air pressure regulator connected by a connecting hose to another one-way check valve, said another one-way check valve connected to another arm of said outlet Tee wherein said outlet Tee has its free arm connected by said at least one connecting hose to said mitt.

4. A device for scrubbing debris, applying germicidal dip and stripping milk from an animal's teat comprises a mitt, a pump unit and at least one connecting hose for connecting said mitt to said pump unit, said pump unit further comprising at least two air pressure regulators, a pump, connecting hoses, at least two one-way check valves and at least one Tee, said pump having a liquid inlet connected to a germicidal container and an air inlet connected to one said pressure regulator, said pump having an outlet connected by a connecting hose to one said one-way check valve, said one-way check valve connected by a connecting hose to one arm of an outlet Tee, another said air pressure regulator connected by a connecting hose to another one-way check valve, said another one-way check valve connected to another arm of said outlet Tee, said mitt comprising an elongated bladder having an exfoliant material applied to one surface thereof, a liquid and air inlet port, a thumb strap, a hand strap and a pinch valve, said thumb strap affixed to one end of said elongated bladder on a surface opposite said exfoliant material, said hand strap spaced from said thumb strap and affixed to said surface opposite said exfoliant material and said liquid and air inlet port affixed to an edge of said elongated bladder between said thumb strap and said hand strap wherein said outlet Tee has its free arm connected to said mitt by said at least one connecting hose.
